(19) United States
(12) Patent Application Publication
(10) Pub. No.: US 2021/0168991 A1
(43) Pub. Date: Jun. 10, 2021

(54) SYSTEM AND METHOD FOR CONTROLLING THE DIRECTION OF TRAVEL OF A WORK VEHICLE BASED ON AN ADJUSTED GUIDANCE LINE

(71) Applicant: CNH Industrial America LLC, New Holland, PA (US)

(72) Inventors: Phillip Dix, Westmont, IL (US); Daniel Geiyer, Bolingbrook, IL (US); Aditya Singh, Bolingbrook, IL (US); Navneet Gulati, Naperville, IL (US)

(73) Assignee: CNH Industrial America LLC

(21) Appl. No.: 16/704,401

(22) Filed: Dec. 5, 2019

(51) Int. Cl. A01B 79/00; A01B 69/04; A01D 41/127; G05D 1/02

(52) U.S. Cl. CPC A01B 79/005; A01B 69/008; G05D 2201/0201; G05D 1/0219; G05D 1/0227; A01D 41/1278

(57) ABSTRACT

A system for controlling a direction of travel of a work vehicle may include a location sensor configured to capture data indicative of a location of the vehicle within a field across which the vehicle is traveling. A controller of the system may be configured to determine the location of the vehicle within the field based on the data captured by the location sensor. Furthermore, the controller may be configured to determine a centerline adjustment value based on a field map associated with the field and the determined location of the vehicle. Moreover, the controller may be configured to adjust a position of a guidance line defined between first and second crop rows within the field such that the guidance line is offset from a centerline between the first and second crop rows by the centerline adjustment value.

### FIELD OF THE INVENTION

The present disclosure generally relates to work vehicles and, more particularly, to systems and methods for controlling the direction of travel of a work vehicle as the vehicle travels across a field based on an adjusted guidance line positioned between a pair of spaced apart crop rows within the field.

### BACKGROUND OF THE INVENTION

A harvester is an agricultural machine used to harvest and process crops. For instance, a combine harvester may be used to harvest grain crops, such as wheat, oats, rye, barley, corn, soybeans, and flax or linseed. In general, the objective is to complete several processes, which traditionally were distinct, in one pass of the machine over a portion of the field. In this respect, most harvesters are equipped with a detachable harvesting implement, such as a header, which cuts and collects the crop from the field. The harvester also includes a crop processing system, which performs various processing operations (e.g., threshing, separating, etc.) on the harvested crop received from the harvesting implement. Furthermore, the harvester includes a crop tank, which receives and stores the harvested crop after processing.

Many crops, such as corn and soybeans, are planted in rows. As such, when the harvester travels across the field, it is desirable that the direction of travel of the harvester be generally aligned with the orientation of the crop rows to maximize harvesting efficiency. For example, some headers may include a plurality of row dividers positioned between the crop rows when the harvester travels across the field to perform the harvesting operation. In this respect, it may be desirable that each row divider be aligned with a centerline defined between the corresponding pair of adjacent crop rows.

As such, some harvesters use mechanical crop row sensors mounted on the row dividers to detect the positions of the crop row dividers relative to the crop row centerlines. However, when the harvester is traveling along a curved path, such mechanical crop row sensors may indicate that the row dividers have deviated from the centerlines when the row dividers are, in fact, aligned with the centerlines. In this respect, the direction of travel of the harvester may be adjusted such that the row dividers are offset from the crop row centerline. In such instances, the crops being collected and cut by the header may contact the row dividers instead of being directed into the stalkways defined between the row dividers, thereby resulting in crop loss.

Accordingly, an improved system and method for controlling the direction of travel of a work vehicle would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for controlling a direction of travel of a work vehicle. The system may include a location sensor configured to capture data indicative of a location of the work vehicle within a field across which the work vehicle is traveling. The field may include a first crop row and a second crop row spaced apart from the first crop row such that a centerline is defined between the first and second crop rows, with the centerline extending parallel to the first and second crop rows. Additionally, the system may include a controller communicatively coupled to the location sensor. As such, the controller may be configured to determine the location of the work vehicle within the field based on the data captured by the location sensor. Furthermore, the controller may be configured to determine a centerline adjustment value based on a field map associated with the field and the determined location of the work vehicle. Moreover, the controller may be configured to adjust a position of a guidance line defined between the first and second crop rows such that the guidance line is offset from the centerline by the centerline adjustment value.

In another aspect, the present subject matter is directed to an agricultural harvester. The agricultural harvester may include a harvesting implement configured to harvest crops present within a field across which the agricultural harvester is traveling. The field may include a first crop row and a second crop row spaced apart from the first crop row such that a centerline is defined between the first and second crop rows, with the centerline extending parallel to the first and second crop rows. Additionally, the agricultural harvester may include a location sensor configured to capture data indicative of a location of the work vehicle within the field. Furthermore, the agricultural harvester may include a controller communicatively coupled to the location sensor. As such, the controller may be configured to determine the location of the work vehicle within the field based on the data captured by the location sensor. Moreover, the controller may be configured to determine a centerline adjustment value based on a field map associated with the field and the determined location of the work vehicle. In addition, the controller may be configured to adjust a position of a guidance line defined between the first and second crop rows such that the guidance line is offset from the centerline by the centerline adjustment value.

In a further aspect, the present subject matter is directed to a method for controlling a direction of travel of a work vehicle traveling across a field. The field may include a first crop row and a second crop row spaced apart from the first crop row such that a centerline is defined between the first and second crop rows, with the centerline extending parallel to the first and second crop rows. The method may include determining, with one or more computing devices, a location of the work vehicle within the field based on received location sensor data. Additionally, the method may include determining, with the one or more computing devices, a centerline adjustment value based on a field map associated with the field and the determined location of the work vehicle. Furthermore, the method may include adjusting, with the one or more computing devices, a position of a guidance line defined between the first and second crop rows such that the guidance line is offset from the centerline by the centerline adjustment value. Moreover, the method may include controlling, with the one or more computing devices, the direction of travel of the work vehicle based on the adjusted centerline.

These and other features, aspects and advantages of the present technology will become better understood with reference to the following description and appended claims. The accompanying drawings, which are incorporated in and constitute a part of this specification, illustrate embodiments of the technology and, together with the description, explain the principles of the technology.

### BRIEF DESCRIPTION OF THE DRAWINGS

A full and enabling disclosure of the present technology, including the best mode thereof, directed to one of ordinary skill in the art, is set forth in the specification, which refers to the appended figures, in which:

FIG. 1 illustrates a partial sectional side view of one embodiment of a work vehicle in accordance with aspects of the present subject matter;

FIG. 2 illustrates a perspective view of the work vehicle shown in FIG. 1, particularly illustrating various components of the work vehicle in accordance with aspects of the present subject matter;

FIG. 3 illustrates a schematic view of one embodiment of a system for controlling a direction of travel of a work vehicle in accordance with aspects of the present subject matter;

FIG. 4 illustrates a top view of one embodiment of a crop row sensor suitable for use within the system shown in FIG. 3 in accordance with aspects of the present subject matter;

FIG. 5 illustrates a top view of a portion of a harvesting implement of a work vehicle positioned relative to a plurality of crop rows within a field in accordance with aspects of the present subject matter, particularly illustrating a row divider of the harvesting implement being aligned with a centerline defined between a pair of adjacent crop rows while being guided relative to a guidance line offset from the centerline; and

FIG. 6 illustrates a flow diagram of one embodiment of a method for controlling a direction of travel of a work vehicle in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for controlling the direction of travel of a work vehicle. Specifically, the present subject matter may be used with an agricultural harvester (e.g., a combine harvester) or any other work vehicle that travels across a field relative to one or more crop rows present within the field. In this respect, as the vehicle travels across the field to perform an operation (e.g., a harvesting operation) thereon, a controller of the disclosed system may be configured to control the direction of travel of the vehicle relative to one or more guidance lines within the field. The guidance line(s) may, in turn, be defined between a pair(s) of adjacent crop rows present within the field. For example, the vehicle may include one or more crop row sensors (e.g., a mechanical or contact-based crop row sensor(s)) coupled to the row divider(s). The crop row sensor(s) may, in turn, be configured to capture data indicative of the position of the row divider(s) relative to the corresponding adjacent crop rows. In this respect, the controller may be configured to control the direction of travel of the vehicle such that data received from the crop row sensor(s) indicates that the row divider(s) are aligned with the guidance line(s).

In accordance with aspects of the present subject matter, the controller may be configured to adjust the position of the guidance line(s) based on a previously-generated field map. In certain instances, such as when the vehicle is traversing a curve, the data captured by the crop row sensor(s) may indicate the corresponding row divider(s) is offset for the corresponding centerline(s) when the row divider(s) is, in fact, aligned with the centerline(s). As such, in several embodiments, the vehicle may include a location sensor (e.g., a GNSS-based sensor) for capturing data indicative of the location of the vehicle within the field. In this respect, as the vehicle travels across the field, the controller may be configured to determine the location of the vehicle based on the data captured by the location sensor. Furthermore, the controller may be configured to determine a centerline adjustment value based on the determined location of the vehicle and a previously generated field map associated with the field (e.g., a field map generated during a previous planting operation). For example, the centerline adjustment value may be based on the orientation (e.g., the curvature) of the crop rows depicted in the field map and/or configuration or geometry of the crop row sensor. Thereafter, the controller may be configured to adjust (e.g., laterally shift) the guidance line(s) relative to the corresponding centerline(s) based on the determined centerline adjustment value.

Adjusting the position of guidance line(s) relative to the corresponding crop row centerline(s) based on the determined centerline adjustment value may reduce crop loss. Specifically, when the data captured by the crop row sensor(s) indicates that the corresponding row divider(s) is aligned with the adjusted guidance line(s), the row divider(s) may, in fact, be aligned with the centerline(s). Thus, the crops present within the field may be directed into the stalkways (and not the sides of the row dividers) when the vehicle travels along a curve, thereby reducing the amount of crops lost during the harvesting process.

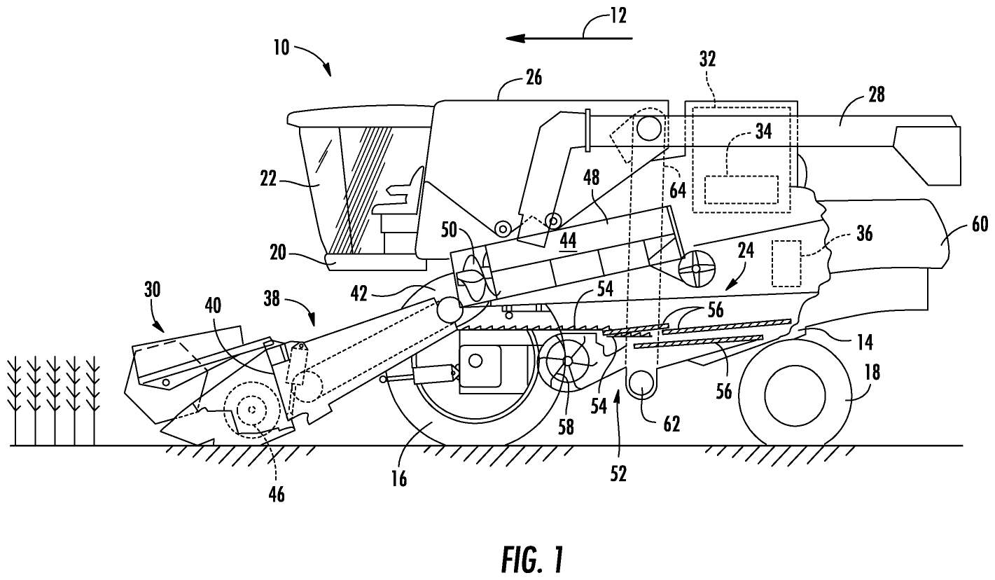

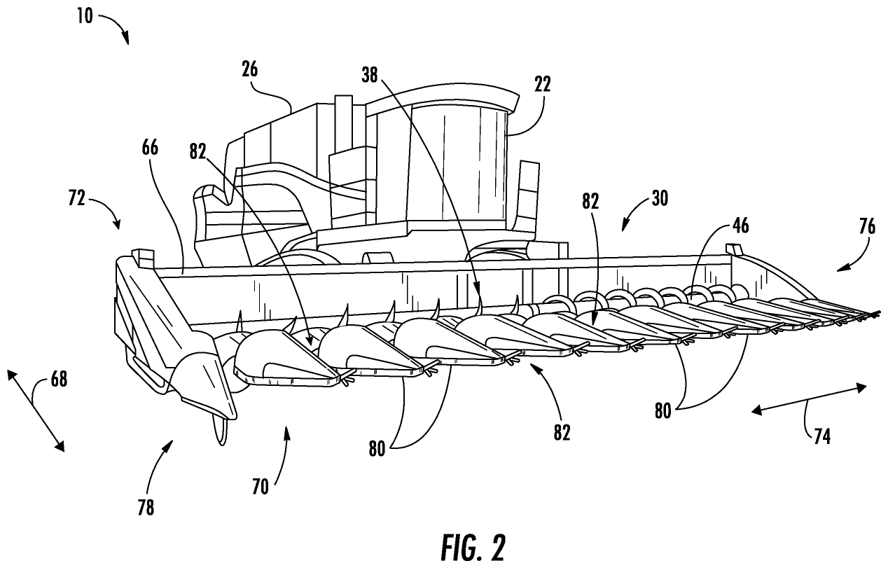

Referring now to the drawings, FIGS. 1 and 2 illustrate differing views of one embodiment of a work vehicle 10 in accordance with aspects of the present subject matter. Specifically, FIG. 1 illustrates a partial sectional side view of the vehicle 10. Additionally, FIG. 2 illustrates a perspective view of the vehicle 10, particularly illustrating various components of the vehicle 10.

In general, the vehicle 10 may be configured to travel across a field in a direction of travel (indicated by arrow 12) to relative to one or more crop rows present within the field. As shown, in several embodiments, the vehicle 10 may be configured as an agricultural harvester (e.g., an axial-flow combine). In such embodiments, while traversing the field, the vehicle 10 may be configured to harvest and subsequently process the crops present within the field. However, in alternative embodiments, the vehicle 10 may be configured as any other suitable type of work vehicle, such as an agricultural sprayer, a tractor, and/or the like.

As shown, the vehicle 10 may include a chassis or main frame 14 configured to support and/or couple to various components of the vehicle 10. For example, in several embodiments, the vehicle 10 may include a pair of driven, ground-engaging front wheels 16 and a pair of steerable rear wheels 18 coupled to the frame 14 As such, the wheels 16, 18 may be configured to support the vehicle 10 relative to the ground and move the vehicle 10 in the direction of travel 12. Furthermore, the vehicle 10 may include an operator's platform 20 having an operator's cab 22, a crop processing system 24, a crop tank 26, and the crop discharge tube 28 that are supported by the frame 14. As will be described below, the crop processing system 24 may be configured to perform various processing operations on the harvested crop as the system 24 transfers the harvested crop between a header 30 of the vehicle 10 and the crop tank 26.

Furthermore, the vehicle 10 may include various drivetrain components. For example, the vehicle 10 may include an engine 32 and a transmission 34 mounted on the frame 14. The transmission 34 may be operably coupled to the engine 32 and may provide variably adjusted gear ratios for transferring engine power to the wheels 16 via a drive axle assembly (or via axles if multiple drive axles are employed). Additionally, the vehicle 10 may include a steering actuator 36 configured to adjust the orientation of the steerable wheels 18 relative to the frame 14. In this respect, the steering actuator 36 may be configured to adjust the direction of travel 12 of the vehicle 10 by adjusting the position of the steerable wheels 18 relative to the frame 14. For example, the steering actuator 36 may correspond to an electric motor, a linear actuator, a hydraulic cylinder, a pneumatic cylinder, or any other suitable actuator coupled to suitable mechanical assembly, such as a rack and pinion or a worm gear assembly.

Moreover, as shown in FIG. 1, a harvesting implement, such as a header 30, and an associated feeder 38 of the crop processing system 24 may extend forward of the frame 14 and may be pivotally secured thereto for generally vertical movement. In general, the feeder 38 may support the header 30. As shown in FIG. 1, the feeder 38 may extend between a front end 40 coupled to the header 30 and a rear end 42 positioned adjacent to a threshing and separating assembly 44 of the crop processing system 24. In this respect, the rear end 42 of the feeder 38 may be pivotally coupled to a portion of the vehicle 10 to allow the front end 40 of the feeder 38 and, thus, the header 30 to be moved vertical up and down relative to the ground to set the desired harvesting or cutting height for the header 30.

As the vehicle 10 travels across the field having one or more crop rows, the crop material is severed from the stubble by a plurality of snapping rolls (not shown) and associated stripping plates (not shown) at the front of the header 30 and delivered by a header auger 46 to the front end 40 of the feeder 38, which supplies the harvested crop to the threshing and separating assembly 44. The threshing and separating assembly 44 may, in turn, include a cylindrical chamber 48 in which a rotor 50 is rotated to thresh and separate the harvested crop received therein. That is, the harvested crop may be rubbed and beaten between the rotor 50 and the inner surfaces of the chamber 48 to loosen and separate the grain, seed, or the like from the straw.

The harvested crop separated by the threshing and separating assembly 44 may fall onto a crop cleaning assembly 52 of the crop processing system 24. In general, the crop cleaning assembly 52 may include a series of pans 54 and associated sieves 56. As such, the separated harvested crop may be spread out via oscillation of the pans 54 and/or sieves 56 and may eventually fall through apertures defined in the sieves 56. Additionally, a cleaning fan 58 may be positioned adjacent to one or more of the sieves 56 to provide an air flow through the sieves 56 that removes chaff and other impurities from the harvested crop. For instance, the fan 58 may blow the impurities off the harvested crop for discharge from the vehicle 10 through the outlet of a straw hood 60 positioned at the back end of the vehicle 10. The cleaned harvested crop passing through the sieves 56 may then fall into a trough of an auger 62, which may be configured to transfer the harvested crop to an elevator 64 for delivery to the crop tank 26.

Referring now to FIG. 2, the header 30 may include a header frame 66. In general, the frame 66 may extend along a longitudinal direction 68 between a forward end 70 and an aft end 72. The frame 66 may also extend along a lateral direction 74 between a first side 76 and a second side 78. In this respect, the frame 66 may be configured to support or couple to a plurality of components of the header 30. For example, a plurality of cones or row dividers 80 and the header auger 46 may be supported by the header frame 66. Additionally, the snapping rolls (not shown) and associated stripping plates (not shown) may also be supported on and coupled to the frame 66.

In several embodiments, as shown in FIG. 2, the header 30 may be configured as a corn header. In such embodiments, the plurality of row dividers 80 may extend forward from the header frame 66 along the longitudinal direction 68. Moreover, the row dividers 80 may be spaced apart along the lateral direction 74 of the header frame 66, with each adjacent pair of row dividers 88 defining an associated stalkway or recess 82 therebetween. As the vehicle 10 is moved across the field, the row dividers 80 separate the stalks of the crop such that the separated stalks are guided into the stalkways 82. Thereafter, the snapping rolls (not shown) pull the stalks downwardly onto the associated stripping plates (not shown) such that the ears of the standing crop are snapped from the associated stalks upon contact with the stripping plates. The auger 46 may then convey the harvested ears to the feeder 38 for subsequent processing by the crop processing system 24 (FIG. 1). However, in alternative embodiments, the header 30 may be configured as any other suitable type of harvesting implement, such as a draper header.

It should be further be appreciated that the configurations of the vehicle 10 described above and shown in FIGS. 1 and 2 are provided only to place the present subject matter in an exemplary field of use. Thus, it should be appreciated that the present subject matter may be readily adaptable to any manner of harvester and/or header configuration.

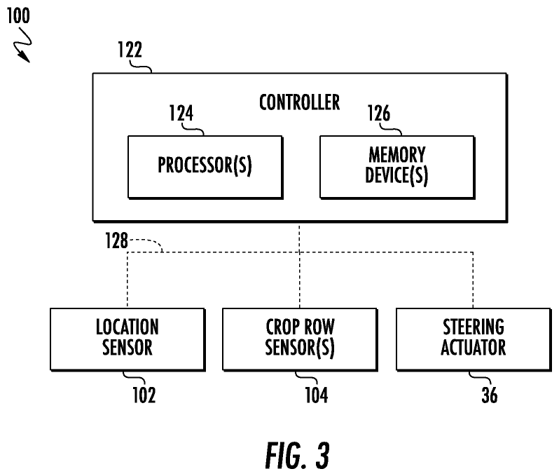

Referring now to FIG. 3, a schematic view of one embodiment of a system 100 for controlling the direction of travel of a work vehicle is illustrated in accordance with aspects of the present subject matter. In general, the system 100 will be described herein with reference to the work vehicle 10 described above with reference to FIGS. 1 and 2. However, it should be appreciated by those of ordinary skill in the art that the disclosed system 100 may generally be utilized with work vehicles having any other suitable vehicle configuration.

As shown in FIG. 3, the system 100 may include a location sensor 102 provided in operative association with the vehicle 10. In general, the location sensor 102 may be configured to capture data indicative of the current location of the vehicle 10 within the field. Specifically, in several embodiments, the location sensor 102 may be configured as a GNSS-based satellite navigation positioning system (e.g. a GPS system, a Galileo positioning system, the Global Navigation satellite system (GLONASS), the BeiDou Satellite Navigation and Positioning system, and/or the like). In such embodiments, the location data captured by the location sensor 102 may be transmitted to a controller(s) of the vehicle 10 (e.g., in the form coordinates) and stored within the controller's memory for subsequent processing and/or analysis. For instance, based on the known dimensional configuration and/or relative positioning between the location sensor 102 and the header 30 (or one or more components of the header 30) of the vehicle 10, the location data from the location sensor 102 may be used to geo-locate or otherwise determine the current location of the header 30 (or one or more components of the header 30) and/or one or more crops row present within the field.

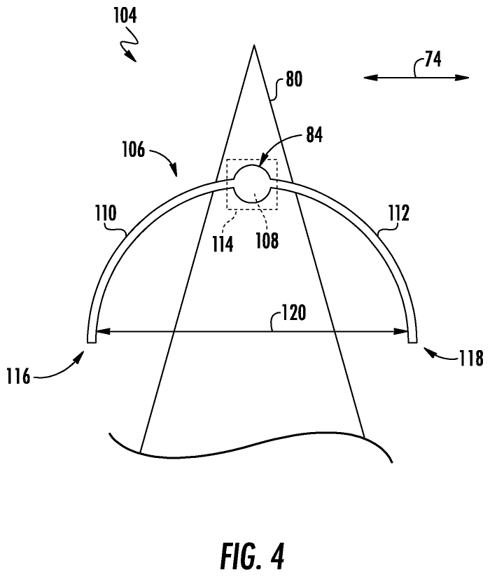

Additionally, the system 100 may include one or more crop row sensors 104 provided in operative association with the vehicle 10. In general, the crop row sensor(s) 104 may be configured to capture data indicative of the location(s) of one or more crop rows present within the field relative to the vehicle 10. In several embodiments, as shown in FIG. 4, each crop row sensor 104 may be configured as a mechanical sensor mounted on a row divider 80 of the header 30 of the vehicle 10. Specifically, in such embodiments, each crop row sensor 104 may include a sensor arm 106 having a base portion 108 installed into an aperture 84 defined by the row divider 80 such that the sensor arm 106 is pivotably coupled to or otherwise able to rotate relative to the row divider 80. Additionally, each crop row sensor 104 may include a potentiometer 114 configured to capture data indicative of the rotation and/or positioning of the base portion 108 relative to the row divider 80. Furthermore, each sensor arm 104 may include first and second sensor arm portions 110, 112 extending outward in the lateral direction 74 from the base portion 108 and rearwardly along the longitudinal direction 68. Thus, the first and second sensor arm portions 110, 112 may generally be curved or arcuate. In this respect, distal ends 116, 118 (i.e., the ends of the sensor arm 106 distal to the base portion 108) of the first and second sensor arm portions 110, 112, respectively, may be spaced apart from each other in the lateral direction 74 by a maximum sensor width (indicated by arrow 120).

As the vehicle 10 travels across the field, the adjacent crop rows present within the field may contact the first and/or second sensor arm portions 110, 112, thereby rotating the sensor arm(s) 106 relative to the row divider(s) 80. For example, when the vehicle 10 travels around a curve, the sensor arm portions 110, 112 positioned on the outside of the curve may contact the adjacent crop row, thereby rotating the sensor arm(s) 106 relative to the row divider(s) 80. The potentiometer(s) 114 may capture data indicative of the rotation of the sensor arm(s) 106 relative to the row divider(s) 80. Such data may then be used to determine the location of the vehicle 10 relative to the adjacent crop rows. However, in alternative embodiments, the crop row sensor(s) 104 may correspond to any other suitable sensor(s) or sensing device(s) for capturing data indicative of the location(s) of one or more crop rows present within the field relative to the vehicle 10.

Referring again to FIG. 3, in accordance with aspects of the present subject matter, the system 100 may include a controller 122 positioned on and/or within or otherwise associated with the vehicle 10. In general, the controller 122 may comprise any suitable processor-based device known in the art, such as a computing device or any suitable combination of computing devices. Thus, in several embodiments, the controller 122 may include one or more processor(s) 124 and associated memory device(s) 126 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 126 of the controller 122 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 126 may generally be configured to store suitable computer-readable instructions that, when implemented by the processor(s) 124, configure the controller 122 to perform various computer-implemented functions.

In addition, the controller 122 may also include various other suitable components, such as a communications circuit or module, a network interface, one or more input/output channels, a data/control bus and/or the like, to allow controller 122 to be communicatively coupled to any of the various other system components described herein (e.g., the steering actuator 36, the location sensor 102, and/or the crop row sensor(s) 104). For instance, as shown in FIG. 3, a communicative link or interface 128 (e.g., a data bus) may be provided between the controller 122 and the components 36, 102, 104 to allow the controller 122 to communicate with such components 36, 102, 104 via any suitable communications protocol (e.g., CANBUS).

It should be appreciated that the controller 122 may correspond to an existing controller(s) of the vehicle 10, itself, or the controller 122 may correspond to a separate processing device. For instance, in one embodiment, the controller 122 may form all or part of a separate plug-in module that may be installed in association with the vehicle 10 to allow for the disclosed systems to be implemented without requiring additional software to be uploaded onto existing control devices of the vehicle 10. It should also be appreciated that the functions of the controller 122 may be performed by a single processor-based device or may be distributed across any number of processor-based devices, in which instance such devices may be considered to form part of the controller 122. For instance, the functions of the controller 122 may be distributed across multiple application-specific controllers, such as a navigation controller, an engine controller, a transmission controller, and/or the like.

In accordance with aspects of the present subject matter, the controller 122 may be configured to control the direction of travel 12 of the vehicle 10 relative to one or more guidance lines within the field. In general, the crops rows present within a field may be spaced apart from each other in the lateral direction 74, with a centerline may being defined between each pair of adjacent crop rows at a location equidistant between the corresponding crop rows. Specifically, in several embodiments, the guidance line(s) may be defined between a pair(s) of adjacent crop rows. In this respect, as the vehicle 10 travels across the field to perform an operation (e.g., an agricultural harvesting operation) thereon, the controller 122 may be configured to control the direction of travel 12 of the vehicle 10 such that received crop row sensor data indicates that one or more components (e.g., a row divider(s) 80) of the vehicle 10 are aligned in the lateral direction 76 with the guidance line(s). As will be described below, in many instances (e.g., when the vehicle 10 is traveling along a generally straight or linear path), the guidance line(s) may be aligned in the lateral direction 76 with the corresponding centerline(s). However, in certain instances (e.g., when the vehicle 10 is traveling along a curved path), the guidance line(s) may be offset from the corresponding centerline(s) in the lateral direction 76.

In several embodiments, the controller 122 may be configured to control the direction of travel 12 of the vehicle 10 relative to the guidance line(s) based on crop row sensor data. As described above, the vehicle 10 may include one or more crop row sensors 104, with each sensor 104 configured to capture data indicative of the position of the row divider 80 to which it is coupled relative to the adjacent crop rows. In this respect, as the vehicle 10 travels across the field to perform the operation thereon, the controller 122 may be configured to receive crop row sensor data from the crop row sensor(s) 104 (e.g., via the communicative link 128). Thereafter, the controller 122 may be configured to analyze or process the received crop row sensor data to determine the position of the corresponding row divider(s) 80 relative to the guidance line(s) defined between the corresponding pair(s) of crop rows. When the positions of the row divider(s) 80 differ from the guidance line(s), the controller 122 may be configured to initiate an adjustment to the direction of travel 12. Such adjustment may, in turn, cause the crop row sensor data to indicate that the row dividers 80 with the guidance line(s). For example, in one embodiment, the controller 122 may be configured to transmit suitable control signals (e.g., via the communicative link 128) to the steering actuator 36. Such control signals may, in turn, instruct the steering actuator 36 to adjust the adjust the orientation of the steerable wheels 18 of the vehicle 10 relative to the vehicle frame 14 such that the direction of travel 12 of the vehicle 10 is changed.

In general, it may be desirable to align one or more components of the vehicle 10 with the centerlines between the crop rows as the vehicle performs the operation. Specifically, in several embodiments, when the vehicle 10 travels across the field to perform a harvesting operation, it may be desirable to align each row divider 80 of the header 30 with the centerline defined between the adjacent pair of crop rows. Such alignment may, in turn, direct the crop rows into the stalkways 82 defined between the row dividers 80 (and not into the row dividers 80), thereby minimizing crop loss during the operation. As such, in many instances, the guidance line(s) may correspond to the centerline(s) between the corresponding pair(s) of crop rows. For example, when the vehicle 10 is traveling relative to portions of the crop rows that are straight or linear, the data captured by the crop row sensor(s) 104 may generally provide a correction indication of the location of the row dividers 80 relative to the corresponding crop row centerlines. That is, the crop row sensor data may indicate that the row dividers 80 are offset from the centerlines in the lateral direction 76 when the row dividers 80 are actually offset from the centerlines between the crop rows. However, in certain instances, such as when crop rows are curved (thereby requiring the vehicle 10 to travel around a curve), the data captured by the crop row sensor(s) 104 may provide an incorrection indication of the location of the row dividers 80 relative to the corresponding crop row centerlines. In such instances, the crop row sensor data may indicate that the row dividers 80 are offset from the centerlines in the lateral direction 76 when the row dividers 80 are, in fact, aligned with the centerlines. As will be described below, in such instances, the controller 122 may adjust the position(s) of the guidance line(s) relative to the corresponding crop row centerlines by a centerline adjustment value such that, when the crop row sensor data indicates that the row dividers 80 are aligned with the guidance line(s), the row dividers 80 are actually aligned with the corresponding crop row centerlines.

In several embodiments, the controller 122 may be configured to determine the position of the vehicle 10 within the field. As described above, the system 100 may include a location sensor 102 configured to capture data indicative of location of the vehicle 10 within the field. In this respect, as the vehicle 10 travels across the field relative to the crop rows, the controller 122 may be configured to receive location data (e.g., coordinates) from the location sensor 102 (e.g., via the communicative link 128). Thereafter, the controller 102 may be configured to determine the location of the vehicle 10 or, more specifically, the header 30 within the field.

Furthermore, the controller 116 may be configured to access a field map associated with a field across which the vehicle 10 is traveling. More specifically, during a previous operation, a field map depicting or otherwise identifying the locations of the crop rows present within the field may be generated. For example, in one embodiment, during a planting operation, a field map depicting the locations where seeds were deposited in the field may be generated, with such locations of the seeds corresponding to the locations of the crop rows. The generated field map may be stored within the memory device(s) 126 of the controller 122 for use during a subsequent operation. Thereafter, when it is desired to perform the subsequent operation (e.g., the harvesting operation), the controller 122 may be configured to retrieve or otherwise access the stored field map from its memory 126.

As used herein, a “field map” may generally correspond to any suitable dataset that correlates data to various locations within a field. Thus, for example, a field map may simply correspond to a data table that provides the locations of the crop rows present within the field. Alternatively, a field map may correspond to a more complex data structure, such as a geospatial numerical model that can be used to identify the locations of the crop rows present within the field.

In accordance with aspects of the present subject matter, the controller 122 may be configured to determine a centerline adjustment value. In general, the centerline adjustment value may correspond to a distance in the lateral direction 76 that the guidance line(s) are offset from the corresponding crop row centerlines. Specifically, in several embodiments, the controller 122 may be configured to calculate or determine the centerline adjustment value based on the determined location of the vehicle 10 within the field and the accessed field map. In such embodiments, the controller 122 may be configured to analyze the accessed field map to determine the orientation of the crop rows present within the field at the current location of the vehicle. In one embodiment, the controller 122 may be configured to determine a radius of the crop rows at the current location of the vehicle 10 based on the field map. Thereafter, in such an embodiment, the controller 122 may be configured to determine the centerline adjustment value based on determined radius. For instance, the controller 122 may include a look-up table(s), suitable mathematical formula, and/or an algorithm(s) stored within its memory device(s) 126 that correlates the determined crop row radius to the centerline adjustment value. Additionally, in some embodiments, the centerline adjustment value may be based on one or more parameters (e.g., the curvature of the first and second arm portions 110, 112; the maximum sensor width 120; and/or the like) associated with the geometry of the crop row sensor(s) 104 in addition to the accessed field map and the determined location of the vehicle 10.

Moreover, the controller 122 may be configured to adjust the guidance lines(s) being used to guide the vehicle 10 relative to the crop rows based on the determined centerline adjustment value. Specifically, the controller 122 may be configured to adjust the position the centerline(s) in the lateral direction 76 relative to the crop row centerline(s). Thus, when the vehicle 10 is traveling around a curve, the guidance lines(s) may be offset from the corresponding centerline(s) in the lateral direction 76. As such, the guidance lines(s) may be closer to one of the adjacent crop rows than the other adjacent crop row. In this respect, when the is traveling around a curve and the crop row sensor data indicates that the row dividers 80 are aligned with the guidance line(s), the row dividers 80 may in fact be aligned with the crop row centerlines. It should be appreciated that the controller 122 may be configured to continuously or periodically (e.g., at a predetermined rate) update the determined centerline adjustment value and adjust the position of the guidance line(s) accordingly.

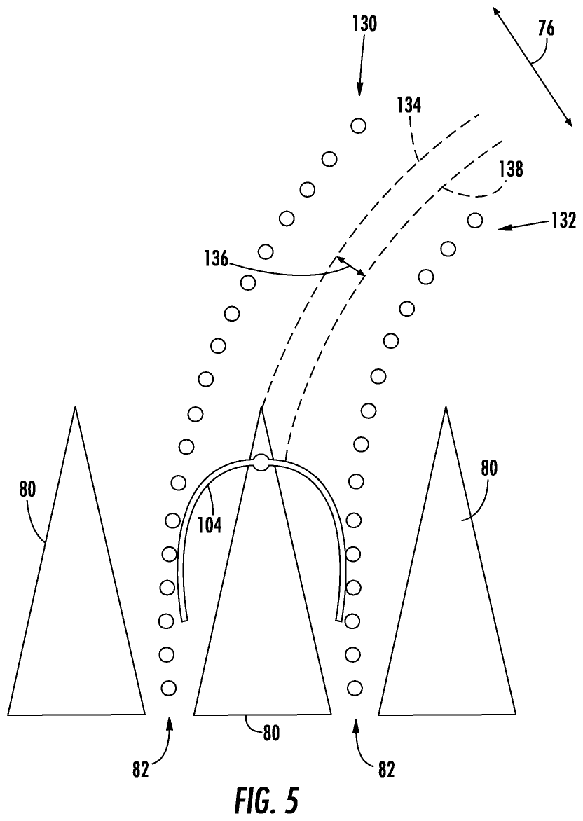

FIG. 5 illustrates an example top view of a portion of the header 30 of the vehicle 10 positioned relative to a plurality of crop rows within the field. More specifically, the illustrated portion of the field includes crop rows 130, 132, with a centerline 134 defined equidistant between the crop rows 130, 132. As shown, the illustrated portions of the crop rows 130, 132 are curved. Although the row divider 80 on which the crop row sensor 104 is mounted is aligned with the centerline 134 in FIG. 5, it may be assumed the data captured by the sensor 104 indicates that the corresponding row divider 80 is offset from the centerline 134. In this respect, the controller 122 may be configured to determine a centerline adjustment value (indicated by arrow 136) based on the curvature (e.g., the radius) of the crop rows 130, 132 and/or the geometry of the crop row sensor 104. Thereafter, the controller 122 may be configured to adjust the position of a guidance line 138 such that the guidance line 138 is offset from the centerline 134 by the centerline adjustment value 136. As shown, the adjusted centerline 138 is closer to the crop row 132 than the crop row 130. As such, the crop row sensor data may indicate the row divider 80 is aligned with the guidance line 138 when the row divider 80 is aligned with the centerline 134

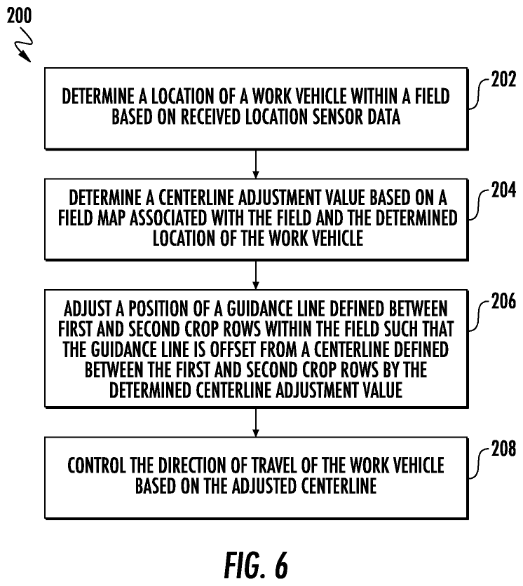

Referring now to FIG. 6, a flow diagram of one embodiment of a method 200 for controlling the direction of travel of a work vehicle is illustrated in accordance with aspects of the present subject matter. In general, the method 200 will be described herein with reference to the work vehicle 10 and the system 100 described above with reference to FIGS. 1-5. However, it should be appreciated by those of ordinary skill in the art that the disclosed method 200 may generally be implemented with any work vehicle having any suitable vehicle configuration and/or within any system having any suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 6, at (202), the method 200 may include determining, with one or more computing devices, a location of a work vehicle within a field based on received location sensor data. For instance, as described above, the controller 122 may be configured to determine the location of the vehicle 10 within a field based on location data received from the location sensor 102.

Additionally, at (204), the method 200 may include determining, with the one or more computing devices, a centerline adjustment value based on a field map associated with the field and the determined location of the work vehicle. For instance, as described above, the controller 122 may be configured to determine a centerline adjustment value based on a field map associated with the field and the determined location of the work vehicle.

Moreover, as shown in FIG. 6, at (206), the method 200 may include adjusting, with the one or more computing devices, a position of a guidance line defined between first and second crop rows within the field such that the guidance line is offset from a centerline defined between the first and second crop rows by the determined centerline adjustment value. For instance, as described above, the controller 122 may be configured to adjust the position of a guidance line defined between first and second crop rows within the field such that the guidance line is offset from the centerline defined between the first and second crop rows by the determined centerline adjustment value.

Furthermore, at (208), the method 200 may include controlling, with the one or more computing devices, the direction of travel of the work vehicle based on the guidance line. For instance, as described above, the controller 122 may be configured to the operation of the steering actuator 36 of the vehicle 10 such that the direction of travel 12 of the vehicle 10 is controlled based on the guidance line.

It is to be understood that the steps of the method 200 are performed by the controller 122 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 122 described herein, such as the method 200, is implemented in software code or instructions which are tangibly stored on a tangible computer readable medium. The controller 122 loads the software code or instructions via a direct interface with the computer readable medium or via a wired and/or wireless network. Upon loading and executing such software code or instructions by the controller 122, the controller 122 may perform any of the functionality of the controller 122 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for controlling a direction of travel of a work vehicle, the system comprising:
a location sensor configured to capture data indicative of a location of the work vehicle within a field across which the work vehicle is traveling, the field including a first crop row and a second crop row spaced apart from the first crop row such that a centerline is defined between the first and second crop rows, the centerline extending parallel to the first and second crop rows; and
a controller communicatively coupled to the location sensor, the controller configured to:
determine the location of the work vehicle within the field based on the data captured by the location sensor;
determine a centerline adjustment value based on a field map associated with the field and the determined location of the work vehicle; and
adjust a position of a guidance line defined between the first and second crop rows such that the guidance line is offset from the centerline by the centerline adjustment value.

2. The system of claim 1, wherein the controller is further configured to control the direction of travel of the work vehicle based on the guidance line.

3. The system of claim 2, further comprising:
a crop row sensor configured to capture data indicative of a position of a component of the work vehicle relative to the first and second crop rows as the work vehicle travels across the field, the controller further configured to:
monitor the position of the component relative to the guidance line based on the data captured by the crop row sensor; and
when the monitored position of the component differs from the position of the guidance line, initiate an adjustment in the direction of travel of the work vehicle.

4. The system of claim 3, wherein the controller is further configured to determine the centerline adjustment value based on a geometry of the crop row sensor, the field map associated with the field, and the determined location of the work vehicle.

5. The system of claim 3, wherein the crop row sensor is configured as a mechanical sensor.

6. The system of claim 5, wherein the crop row sensor comprises a sensor arm having first and second arm portions configured to contact the first and second crop rows, respectively, as the work vehicle travels across the field.

7. The system of claim 5, wherein the crop row sensor is pivotably coupled to the guide component of the work vehicle.

8. The system of claim 1, wherein the guidance line is closer to one of the first or second crops rows than the other of the first or second crop rows.

9. The system of claim 1, wherein the first crop row is spaced apart from the second crop row in a lateral direction, the centerline adjustment value corresponding to a distance extending along the lateral direction.

10. The system of claim 1, wherein the work vehicle is configured as an agricultural harvester.

11. An agricultural harvester, comprising:
a harvesting implement configured to harvest crops present within a field across which the agricultural harvester is traveling, the field including a first crop row and a second crop row spaced apart from the first crop row such that a centerline is defined between the first and second crop rows, the centerline extending parallel to the first and second crop rows;
a location sensor configured to capture data indicative of a location of the work vehicle within the field; and
a controller communicatively coupled to the location sensor, the controller configured to:
determine the location of the work vehicle within the field based on the data captured by the location sensor;
determine a centerline adjustment value based on a field map associated with the field and the determined location of the work vehicle; and
adjust a position of a guidance line defined between the first and second crop rows such that the guidance line is offset from the centerline by the centerline adjustment value.

12. The agricultural harvester of claim 11, further comprising:
a crop row sensor coupled to a row divider of the harvesting implement, the crop row sensor configured to capture data indicative of a position of the row divider relative to the first and second crop rows as the work vehicle travels across the field, the controller further configured to:
monitor the position of the row divider relative to the adjusted centerline based on the data captured by the crop row sensor; and
when the monitored position of the row divider differs from the position of the guidance line, initiate an adjustment in the direction of travel of the work vehicle.

13. The agricultural harvester of claim 12, wherein the crop row sensor is configured as a mechanical sensor.

14. The agricultural harvester of claim 13, wherein the crop row sensor comprises a sensor arm pivotably coupled to the row divider, the sensor arm including first and second arm portions configured to contact the first and second crop rows, respectively, as the work vehicle travels across the field.

15. A method for controlling a direction of travel of a work vehicle traveling across a field, the field including a first crop row and a second crop row spaced apart from the first crop row such that a centerline is defined between the first and second crop rows, the centerline extending parallel to the first and second crop rows, the method comprising:
determining, with one or more computing devices, a location of the work vehicle within the field based on received location sensor data;
determining, with the one or more computing devices, a centerline adjustment value based on a field map associated with the field and the determined location of the work vehicle;
adjusting, with the one or more computing devices, a position of a guidance line defined between the first and second crop rows such that the guidance line is offset from the centerline by the centerline adjustment value; and
controlling, with the one or more computing devices, the direction of travel of the work vehicle based on the guidance line.

16. The method of claim 15, further comprising:
receiving, with the one or more computing devices, crop row sensor data indicative of a position of a component of the work vehicle relative to the first and second crop rows as the work vehicle travels across the field;
monitoring, with the one or more computing devices, the position of the component relative to the adjusted centerline based on the data captured by the crop row sensor; and
when the monitored position of the component differs from the position of the adjusted centerline, initiating, with the one or more computing devices, an adjustment in the direction of travel of the work vehicle.

17. The method of claim 15, wherein the guidance line is closer to one of the first or second crops rows than the other of the first or second crop rows.

18. The method of claim 15, wherein the first crop row is spaced apart from the second crop row in a lateral direction, the centerline adjustment value corresponding to a distance extending along the lateral direction.

19. The method of claim 15, wherein the work vehicle is configured to perform an agricultural harvesting operation on the field as the work vehicle travels across the field.
